(19) United States
(12) Patent Application Publication
(10) Pub. No.: US 2026/0358977 A1
(43) Pub. Date: Nov. 12, 2026

(54) CYCLIC REDUNDANCY CHECK (CRC) TO DETECT ERRORS ASSOCIATED WITH LOGICAL TO PHYSICAL (L2P) MAPPING DATA IN VOLATILE MEMORY

(71) Applicant: MICRON TECHNOLOGY, INC., Boise, ID (US)

(72) Inventor: Sai Krishna Mylavarapu, Folsom, CA (US)

(21) Appl. No.: 19/670,516

(22) Filed: May 7, 2026

Related U.S. Application Data
(60) Provisional application No. 63/801,970, filed on May 8, 2025.

(51) Int. Cl. G06F 3/06; G06F 12/06

(52) U.S. Cl. CPC G06F 3/0655; G06F 3/0604; G06F 3/0679; G06F 12/06; G06F 2212/7201

(57) ABSTRACT

A system includes a non-volatile memory device; a volatile memory device, wherein the volatile memory device stores a logical to physical (L2P) mapping data structure, wherein the L2P mapping data structure includes a plurality of L2P entries, and wherein each L2P entry of the plurality of L2P entries maps a logical address to a corresponding physical address; and a processing device, operatively coupled with the volatile memory device and the non-volatile memory device, to perform operations including: writing, in a first L2P entry of the plurality of L2P entries, a first logical address specified in a write request and a first physical address; encoding the first L2P entry by applying a cyclic redundancy check (CRC) code to the first L2P entry to generate a CRC encoding value of the first L2P entry; storing the CRC encoding value of the first L2P entry in the non-volatile memory device; receiving a read request to read data stored in the non-volatile memory device, wherein the read request includes the first logical address; and detecting, using the CRC encoding value of the first L2P entry, a first L2P CRC failure of the first L2P entry, wherein the first L2P CRC failure of the first L2P entry indicates an occurrence of an error in the first L2P entry.

### RELATED APPLICATIONS

This application claims the benefit of U.S. Provisional Patent Application No. 63/801,970, filed May 8, 2025, the entire contents of which are incorporated by reference herein.

### TECHNICAL FIELD

Embodiments of the disclosure relate generally to memory sub-systems, and more specifically, relate to implementing cyclic redundancy check (CRC) to detect errors associated with logical to physical (L2P) mapping data in volatile memory.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 illustrates a block diagram of a system that implements cyclic redundancy check (CRC) to detect errors associated with logical to physical (L2P) mapping data in a dynamic random access memory (DRAM) in a memory sub-system in accordance with some embodiments of the present disclosure.

FIG. 3 illustrates data flow of implementing cyclic redundancy check (CRC) to detect errors associated with logical to physical (L2P) mapping data in a dynamic random access memory (DRAM) in a memory sub-system in accordance with some embodiments of the present disclosure.

FIG. 4 illustrates an example logical to physical (L2P) mapping table in a memory sub-system, in accordance with some embodiments of the present disclosure.

FIGS. 5 and 6 are flow diagrams of example methods to implement cyclic redundancy check (CRC) to detect errors associated with logical to physical (L2P) mapping data in a volatile memory device in a memory sub-system in accordance with some embodiments of the present disclosure.

FIG. 7 is a block diagram of an example computer system in which embodiments of the present disclosure may operate.

### DETAILED DESCRIPTION

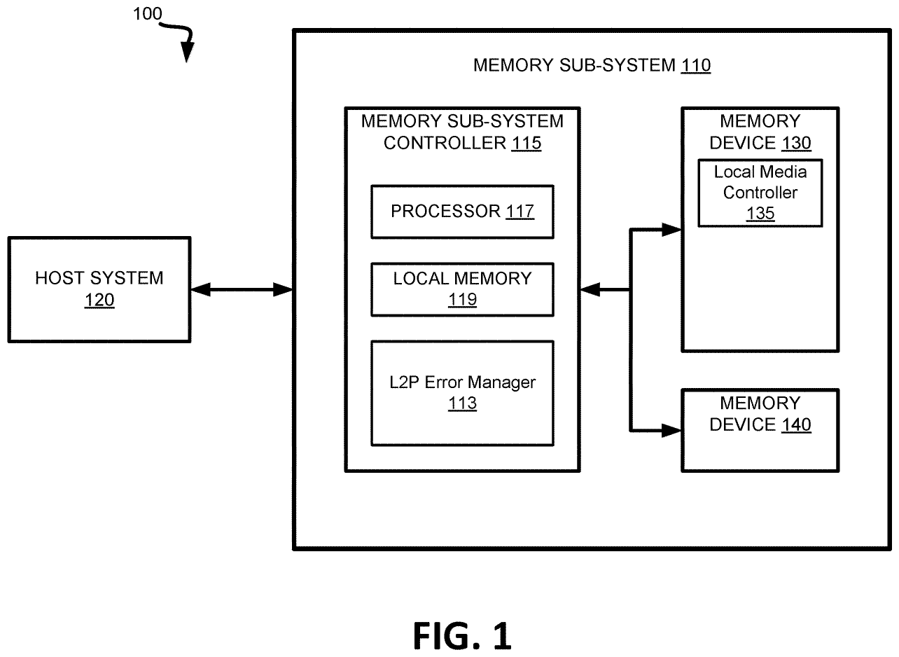

Aspects of the present disclosure are directed to implementing cyclic redundancy check (CRC) to detect errors associated with logical to physical (L2P) mapping data in volatile memory, such as dynamic random access memory (DRAM), in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a negative-and (NAND) memory device. Other examples of non-volatile memory devices are described below in conjunction with FIG. 1. A non-volatile memory device is a package of one or more dies. Each die can consist of one or more planes. For some types of non-volatile memory devices (e.g., NAND devices), each plane consists of a set of physical blocks. Each block consists of a set of pages. Each page consists of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or three-dimensional grid. The memory cells are formed onto a silicon wafer in an array of columns and rows. A wordline can refer to one or more rows of memory cells of a memory device, and a bitline can refer to one or more columns of memory cells of a memory device. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form a plane of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types.

As described above, a die can contain one or more planes. A memory sub-system can use a striping scheme to treat various sets of data as units when performing data operations (e.g., write, read, erase, etc.). A die stripe refers to a collection of planes that are treated as one unit when writing, reading, or erasing data. A controller of a memory device (i.e., a memory sub-system controller, a memory device controller, etc.) can execute the same operation, in parallel, at each plane of a die stripe. A block stripe is a collection of blocks, at least one from each plane of a die stripe, that are treated as a unit. The blocks in a block stripe can be associated with the same block identifier (e.g., block number) at each respective plane. A page stripe is a set of pages having the same page identifier (e.g., the same page number), across a block stripe, and treated as a unit.

One type of cell is a single level cell (SLC), which stores 1 bit per cell and defines 2 logical states (“states”) (“1” or “L0” and “0” or “L1”) each corresponding to a respective V_{T}level. For example, the “1” state can be an erased state and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”) each corresponding to a respective V_{T} level. For example, the “11” state can be an erased state and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”) each corresponding to a respective V_{T} level. For example, the “111” state can be an erased state and each of the other states can be a respective programmed state. Another type of a cell is a quad-level cell (QLC), which stores 4 bits per cell and defines 16 states L0−L15, where L0 corresponds to “1111” and L15 corresponds to “0000”. Another type of cell is a penta-level cell (PLC), which stores 5 bits per cell and defines 32 states. Other types of cells are also contemplated. Thus, an n-level cell can use 2″ levels of charge to store n bits. A memory device can include one or more arrays of memory cells such as SLCs, MLCs, TLCs, QLCs, PLCs, etc. or any combination of such. For example, a memory device can include an SLC portion, and an MLC portion, a TLC portion, a QLC portion, or a PLC portion of cells.

A host system can initiate a memory access operation (e.g., a programming or write operation, a read operation, an erase operation, etc.) on a memory sub-system. For example, the host system can transmit a request to a memory sub-system controller, to program data to and/or read data from a memory device of the memory sub-system. Such data is referred to herein as “host data.” The memory sub-system controller can execute one or more operations to access the host data in accordance with the request. Host data can be encoded using error-correcting code (ECC)) to correct data errors that can occur during transmission or storage. In particular, the host data can be encoded using redundancy metadata (e.g., parity data such as one or more parity bits) to form a codeword. The parity data allows the memory sub-system controller to detect a number of errors that may occur anywhere in the host data, and often to correct these errors without retransmission.

In some systems, a memory sub-system can routinely perform data integrity checks to verify that the data stored at the block can be reliably read. In an example, the memory sub-system controller can select a block and perform the data integrity check on some to all of the pages of the block. During the data integrity check, which can measure and collect information about error rates associated with data, values of a data state metric are determined for data stored at the block. “Data state metric” herein shall refer to a quantity that is measured or inferred from the state of data stored on a memory device. Specifically, data state metrics may reflect the state of the temporal voltage shift, the degree of read disturb, and/or other measurable functions of the data state. One example of a data state metric is bit error count (BEC). Another example of a data state metric is raw bit error rate (RBER). The RBER corresponds to a number of bit errors per unit of time that the data stored at the data block experiences (e.g., BEC/total bits read). A data state metric value exceeding a threshold value can trigger a media management operation (e.g., a folding operation).

In some systems, a memory sub-system that includes the non-volatile memory device (e.g., solid-state drive (SSD)) can also include a volatile memory device (e.g., dynamic random access memory (DRAM)), where the volatile memory device can be used by the memory sub-system controller to facilitate the performance of various memory access operations on the non-volatile memory device. For example, the memory sub-system can maintain a data structure that maps each logical address to a corresponding physical address, where the data structure can be referred to as a logical-to-physical (L2P) mapping data structure. The L2P mapping data structure can be maintained by the firmware of the memory sub-system controller and can be stored on one or more non-volatile memory devices of the memory sub-system, or can at least partially be cached by one or more volatile memory devices of the memory sub-system to improve the overall efficiency of the data transfer between a host system and the memory sub-system.

In certain cases, the failure caused by uncorrectable errors in the data stored in the non-volatile memory device (e.g., NAND-flash memory) can be attributed in a great percentage to the failure of the volatile memory device (e.g., dynamic random access memory (DRAM)). For example, errors can occur during transmission or storage of data (“L2P mapping data”) in the L2P mapping data structure in the DRAM, and these errors will ultimately lead to errors in performing the memory access operations on the non-volatile memory because the correct physical address of the non-volatile memory cannot be identified through the L2P mapping data. As the size of the non-volatile memory is increased, the size of L2P mapping data also increases, leading to an increased number of errors of L2P mapping data occurring in the DRAM, which can constitute a large portion of the number of errors occurring in the memory sub-system.

Aspects of the present disclosure address the above and other deficiencies by implementing cyclic redundancy check (CRC) to detect errors associated with logical to physical (L2P) mapping data in volatile memory, such as dynamic random access memory (DRAM), in a memory sub-system. Upon detecting the errors, the row sparing may be used to handle defective rows of the L2P mapping data in DRAM by remapping the rows to spare rows.

Specifically, the memory sub-system controller can receive a write request to write host data in the non-volatile memory device in the memory sub-system, where the write request includes a logical address. The memory sub-system controller may maintain an L2P mapping data structure stored in the DRAM in the memory sub-system. Upon storing the host data in a physical location, represented by a physical address, of the non-volatile memory device in the memory sub-system, the memory sub-system controller may write, in an L2P entry of the L2P mapping data structure in the DRAM, the logical address specified in the write request and the physical address that stores the host data. The firmware (e.g., an L2P error manager) running on a memory sub-system controller may encode the L2P entry by applying a cyclic redundancy check (CRC) code to the L2P entry to generate a CRC encoding value of the L2P entry. The firmware may store the CRC encoding value of the L2P entry in the non-volatile memory device, for example, along with the host data at the physical location of the non-volatile memory device.

The memory sub-system controller can receive a read request to read data stored in the non-volatile memory device in the memory sub-system, where the read request includes a logical address. The memory sub-system controller may check the L2P mapping data structure to identify a specific L2P entry including the logical address specified in the read request and obtain a physical address corresponding to the logical address in the L2P entry. The firmware may access the physical address, which represents the physical locations of the non-volatile memory device, to retrieve the CRC encoding value of the L2P entry stored at the physical address. The firmware can decode the L2P entry, stored in the DRAM, using the CRC encoding value to generate a CRC decoding value, and then compare the CRC decoding value with a preset value to determine whether the L2P CRC failure occurs. The L2P CRC failure of an L2P entry indicates an occurrence of an error in the L2P entry. For example, responsive to determining that the CRC decoding value does not equal the preset value, the firmware may determine that the L2P CRC failure occurs; while responsive to determining that the CRC decoding value equals the preset value, the firmware may determine that the L2P CRC failure does not occur.

Upon detecting an L2P CRC failure, the firmware can use the logical address specified in the read request to find a match in metadata stored in the non-volatile memory device, where the matched metadata is associated with the data stored in the correct physical address, and thus the firmware can identify the correct physical address. The correct physical address can be used to update the data structure to correct the error associated with L2P CRC failure. Specifically, the firmware can write a new L2P entry in the L2P mapping data structure using a post package repair (PPR) spare row of the volatile memory device, where the new L2P entry maps the correct physical address to the logical address, and the firmware can point the L2P entry associated with the L2P mismatch to the new L2P entry such that the access to the L2P entry can be redirected to the new L2P entry.

Advantages of the present disclosure include reducing the number of the failures caused by uncorrectable errors in the data stored in the non-volatile memory device, without the need of specialized reliability, availability, and serviceability (RAS) solution. The specific L2P CRC implementation can be implemented as firmware without additional change to hardware.

Aspects of the present disclosure do not require overprovisioned capacity of the volatile memory device (e.g., DRAM). Aspects of the present disclosure do not require specific error correcting code (EEC) implementation in the volatile memory device (e.g., DRAM). Various aspects of the above referenced methods and systems are described in details herein below by way of examples, rather than by way of limitation.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device(s) 130) include negative-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s) 130 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, electrically erasable programmable read-only memory (EEPROM).

A memory sub-system controller 115 (or controller 115 for simplicity) can communicate with the memory device(s) 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) 130. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device(s) 130. The memory sub-system controller 115 can further include host interface circuitry to communicate with the host system 120 via the physical host interface. The host interface circuitry can convert the commands received from the host system into command instructions to access the memory device(s) 130 as well as convert responses associated with the memory device(s) 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) 130.

In some embodiments, the memory device(s) 130 include local media controllers 135 that operate in conjunction with memory sub-system controller 115 to execute operations on one or more memory cells of the memory device(s) 130. An external controller (e.g., memory sub-system controller 115) can externally manage the memory device 130 (e.g., perform media management operations on the memory device(s) 130). In some embodiments, a memory device 130 is a managed memory device, which is a raw memory device (e.g., memory array 104) having control logic (e.g., local controller 135) for media management within the same memory device package. An example of a managed memory device is a managed NAND (MNAND) device. Memory device(s) 130, for example, can each represent a single die having some control logic (e.g., local media controller 135) embodied thereon. In some embodiments, one or more components of memory sub-system 110 can be omitted.

In one embodiment, memory sub-system 110 includes an L2P error manager 113 that can implement detection of errors associated with L2P mapping data in the volatile memory device (e.g., memory device 140 or as part of local memory 119) using cyclic redundancy check (CRC) and correct the errors to reduce the errors associated with the memory access operations on the non-volatile memory device (e.g., memory device 130). In some embodiments, memory sub-system controller 115 includes at least a portion of L2P error manager 113. In some embodiments, L2P error manager 113 is part of the memory device 140. In other embodiments, local media controller 135 includes at least a portion of L2P error manager 113 and is configured to perform the functionality described herein. Further details with regards to the operations of L2P error manager 113 are described below.

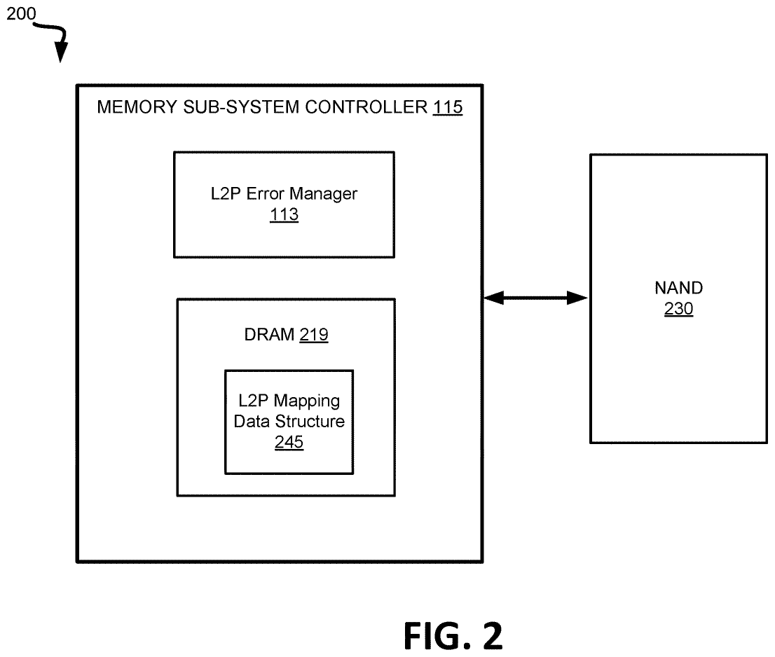

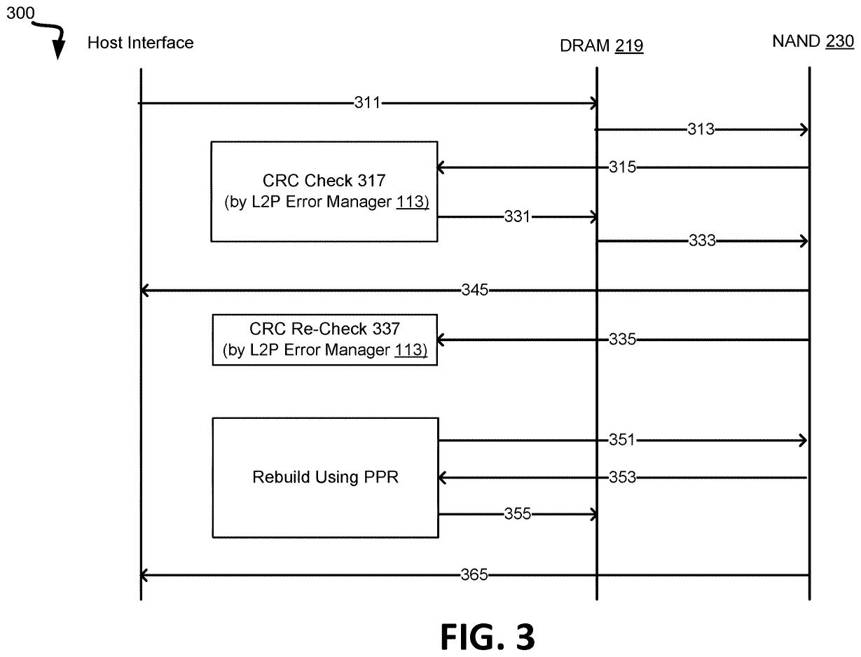

FIG. 2 illustrates a block diagram of a system that includes an example L2P error manager 113 that implements detection of errors associated with L2P mapping data in volatile memory device (e.g., DRAM 219) using cyclic redundancy check (CRC) and correct the errors to reduce the errors associated with the memory access operations on the non-volatile memory device (e.g., NAND 230) in accordance with some embodiments of the present disclosure. FIG. 3 illustrates data flow of implementing cyclic redundancy check (CRC) to correct errors associated with L2P mapping data in a volatile memory device (e.g., DRAM 219) in a memory sub-system in accordance with some embodiments of the present disclosure.

Referring to FIG. 2, system 200 can include non-volatile memory device NAND 230, and memory sub-system controller 115. System 200 can represent memory sub-system 110 of

FIG. 1. In some embodiments, the NAND 230 can be the same as or part of memory device 130. Memory sub-system controller 115 can include L2P error manager 113 and DRAM 219 (e.g., as part of local memory 119 or memory device 140). The DRAM 219 may store L2P mapping data structure 245. In some embodiments, the L2P mapping data structure 245 can be part of controller 115. In some implementations, the L2P mapping data structure 245 can have a copy stored in the NAND 230, or the L2P mapping data structure 245 can be a cached copy of part of an L2P mapping data structure stored in the NAND 230. The memory sub-system controller 115 can execute write commands submitted to the memory sub-system by the host system 120 and/or write commands initiated by controller 115 (e.g., garbage collection). The memory sub-system controller 115 can generate and maintain the L2P mapping data structure 245.

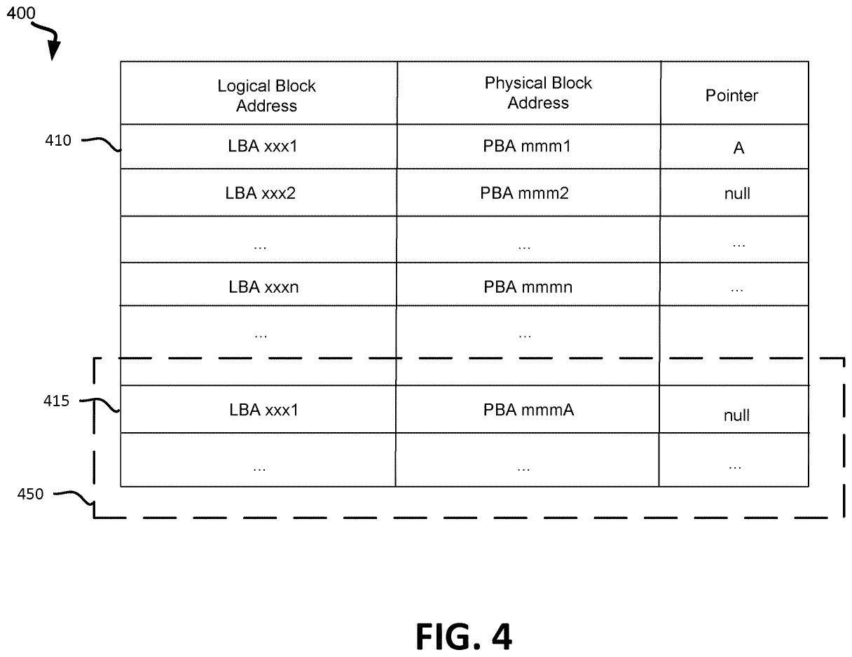

FIG. 4 illustrates an example L2P mapping data structure 245 as the L2P table 400 in a memory sub-system, in accordance with some embodiments of the present disclosure. L2P table 400 can include one or more entries. Each entry can include a logical block address (LBA) field that is configured to store an address (or an identifier) associated with an LBA. Each entry can also include a physical block address (PBA) field that is configured to store an address (or an identifier) associated with a PBA (e.g., residing at NAND 230). In some embodiments, the memory sub-system controller 115 can generate a mapping between an address or identifier associated with a particular LBA and an address or identifier associated with a particular PBA, for example, during an initialization of the memory sub-system 110. The memory sub-system controller 115 can store the generated mapping at DRAM 219.

Referring to FIG. 2, to perform a write operation, the host system 120 may send the write request to write the host data in the NAND 230, where the write request may include the host data and the corresponding LBA. Upon receiving the write request from the host system 120, the memory sub-system controller 115 may create a new L2P entry by writing the LBA in the L2P entry, and the memory sub-system controller 115 may store the host data in a physical location in the NAND 230 and retrieve the PBA of the physical location to write in the L2P entry. The L2P error manager 113 may encode the L2P mapping data (e.g., LBA, PBA, etc.) stored in the L2P entry by applying a cyclic redundancy check (CRC) code to the L2P entry to generate a CRC encoding value (e.g., CRC checksum) of the L2P entry. The L2P error manager 113 may store the CRC encoding value, along with the host data, in the NAND 230. That is, the DRAM 219, which stores the L2P entry of the L2P mapping data structure, does not store the

CRC encoding value of the L2P entry, but the NAND 230 is used to store the CRC encoding value of the L2P entry. The CRC encoding value of the L2P entry can be used to detect errors associated with L2P mapping data in DRAM as described below.

Referring to FIG. 3, at operation 311, the memory sub-system controller 115 may receive a read request to perform a read operation on one or more memory cells of NAND 230. In one embodiment, the read request may include logical addresses such as logical block addresses. For example, the memory sub-system controller 115 may initiate a read operation with respect to a set of target cells in a block in response to receiving the read request, where the read request may include the logical block address of the set of target cells of the block. The memory sub-system controller 115 may check the L2P mapping data structure 245 stored in the DRAM 219 to determine the physical block address that maps to the logical block address included in the read request. At operation 313, the memory sub-system controller 115 may use the physical block address to perform the read operation on the NAND 230.

In some implementations, at operation 315, the L2P error manager 113 may detect the L2P CRC failure, where the L2P CRC failure indicates that the L2P entry associated with the physical block address contains an error. Specifically, the L2P error manager 113 may use the physical block address to retrieve CRC encoding value (of the L2P entry) that is stored with the host data on the physical block address. The L2P error manager 113 may decode the L2P entry (stored in DRAM 219) using the CRC encoding value to generate a CRC decoding value and compare the CRC decoding value with a preset value (“0”). Responsive to determining that the CRC decoding value does not equal the preset value, the L2P error manager 113 may determine that the L2P CRC failure occurs.

In some implementations, upon detecting the L2P CRC failure, the L2P error manager 113 may re-check the L2P CRC failure. For example, at operation 331, the memory sub-system controller may check again the L2P mapping data structure 245 stored in the DRAM 219 to determine the physical block address that maps to the logical block address included in the read request. At operation 333, the memory sub-system controller 115 may use the physical block address to retrieve the CRC encoding value that is stored with the host data on the physical block address. The L2P error manager 113 may decode the L2P entry (stored in DRAM 219) using the CRC encoding value to generate a CRC decoding value and compare the CRC decoding value with a preset value (“0”). In some implementations, at operation 345, the L2P error manager 113 may determine that the CRC decoding value equals the preset value to determine that the L2P CRC failure does not occur and send the data read from the NAND to the host system 120. At operation 335, the L2P error manager 113 may determine that CRC decoding value does not equal the preset value to determine that the L2P CRC failure occurs.

Upon detecting the L2P CRC failure, the memory sub-system controller 115 (or the L2P error manager 113) may rebuild the L2P mapping data by using post package repair (PPR) spare rows. For example, in the example illustrated in FIG. 4, the post package repair (PPR) spare rows 450 of the DRAM 219 is used for rebuilding the L2P mapping data.

Specifically, for example, the memory sub-system controller 115 may assign a tag (as metadata) to the data when performing the write operation to write the host data in the NAND 230. The tag may include logical block address, the physical location in NAND 230, the error correcting code, etc. At operation 351, the L2P error manager 113 may use the logical block address specified in the read request to compare with tags in the NAND 230, and upon finding a match of the logical block address with logical block address contained in one or more tags, at operation 353, the L2P error manager 113 may retrieve the physical location (e.g., physical block address) that stores the tag(s) including the matched logical block address. This physical block address may be the correct one and used to make correction to the L2P mapping data. Upon receiving the correct physical block address, at operation 365, the L2P error manager 113 may use the correct physical block address (e.g., PBA mmmA) to retrieve the read data in the NAND 230, and send the retrieved data to the host system.

Upon retrieving the correct physical block address, at operation 355, the L2P error manager 113 may update the data structure 245 stored in the DRAM 219 by using the post package repair (PPR) spare rows to create a new L2P entry including the correct physical block address and redirect the L2P entry associated with L2P CRC failure to the new L2P entry. As illustrated in the example of FIG. 4, the read request may include the LBA xxx1, and the L2P error manager 113 may retrieve the PBA mmm1 based on the entry 410 of the data structure 400 according to the read request. The L2P error manager 113 may determine an L2P CRC failure of the entry 410 as described above. To rebuild the L2P mapping data for entry 410, the L2P error manager 113 may compare LBA xxx1 specified in the read request with tags in the NAND 230. The L2P error manager 113 may find a match of LBA xxx1 with logical block address contained in one or more tags in the NAND 230. Upon finding a match of LBA xxx1 with logical block address contained in the tag(s), the L2P error manager 113 may retrieve the physical block address (e.g., PBA mmmA) that stores the tag(s) of the matched logical block address. The L2P error manager 113 may add a pointer A to direct the entry 410 to the entry 415, where in the entry 415, the same LBA xxx1 maps to the PBA mmmA that is the correct physical address. The region 450 represents the post package repair (PPR) spare rows that can be used to correct the errored entry of the data structure 400. As described above, the entry 415 is used for the redirection of entry 410 to retrieve the correct physical block address (e.g., PBA mmmA). For example, when a new read request that include LBA xxx1 is received from the host system, the L2P error manager 113 may check the L2P mapping table 400, identify the entry 410 including LBA xxx1 in the L2P mapping table 400, use the pointer A in the entry 410 to redirect to entry 415, and retrieve PBA mmmA in the entry 415 as the physical block address. In some implementations, the memory sub-system can determine the unused physical capacity of the volatile memory device (e.g., DRAM 219), and allocate, based on row fail rate of the memory device, an amount of the blocks to provide the post package repair (PPR) spare rows for the L2P mapping data structure.

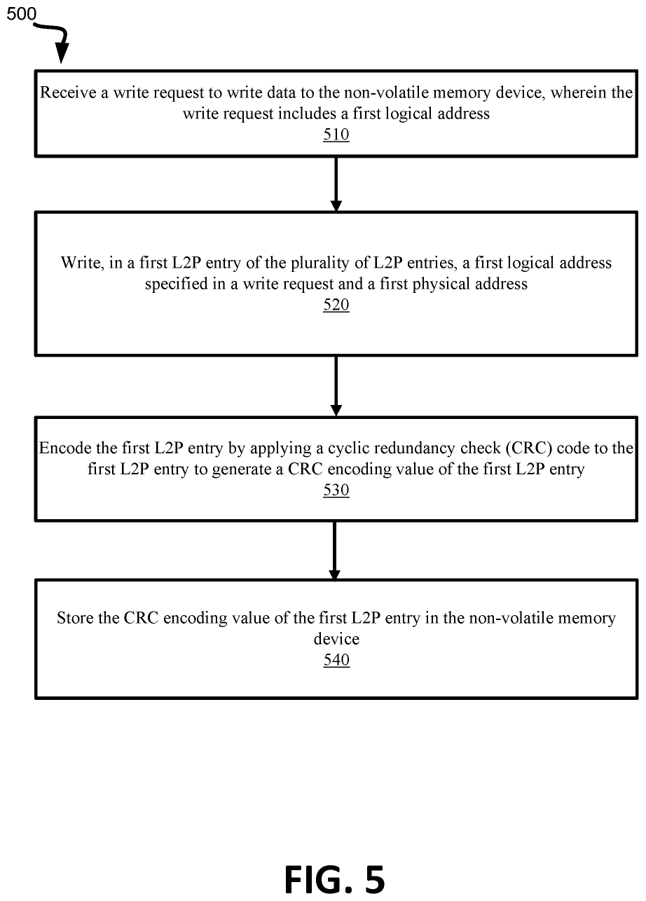

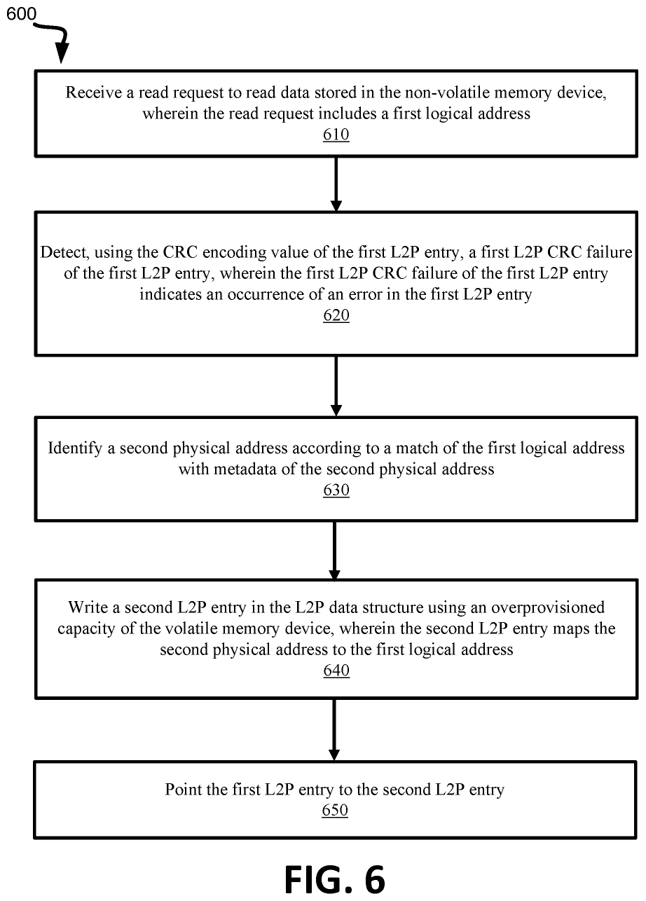

FIGS. 5 and 6 are flow diagrams of example methods to implement cyclic redundancy check (CRC) to detect errors associated with logical to physical (L2P) mapping data in a volatile memory device in a memory sub-system in accordance with some embodiments of the present disclosure. The methods 500 and 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the methods 500 and 600 are performed by the L2P error manager 113 or memory sub-system controller 115 of FIGS. 1-3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

In some implementations, the volatile memory device (e.g., DRAM 219) stores a logical to physical (L2P) mapping data structure (e.g., L2P mapping data structure 245), the L2P mapping data structure includes a plurality of L2P entries, and each L2P entry of the plurality of L2P entries maps a logical address to a corresponding physical address. In some implementations, the non-volatile memory device comprises a dynamic random access memory (DRAM) device.

Referring to FIG. 5, at operation 510, the processing device may receive a write request to write data stored in the non-volatile memory device (e.g., NAND 230), wherein the write request includes a first logical address.

At operation 520, the processing device may write, in a first L2P entry (e.g., entry 410) of the plurality of L2P entries in the L2P mapping data structure (e.g., L2P mapping data structure 245) in the volatile memory device (e.g., DRAM 219), the first logical address (e. g., LBA xxx1) specified in a write request and a first physical address.

At operation 530, the processing device may encode the first L2P entry by applying a cyclic redundancy check (CRC) code to the first L2P entry to generate a CRC encoding value of the first L2P entry.

At operation 540, the processing device may store the CRC encoding value of the first L2P entry in the non-volatile memory device (e.g., NAND 230). In some implementations, the processing device may still store the first L2P entry in the volatile memory device (e.g., DRAM 219).

Referring to FIG. 6, at operation 610, the processing device may receive a read request to read data stored in the non-volatile memory device (e.g., NAND 230), where the read request includes a first logical address (e. g., LBA xxx1).

At operation 620, the processing device may detect, using the CRC encoding value of the first L2P entry, a first L2P CRC failure of the first L2P entry, wherein the first L2P CRC failure of the first L2P entry indicates an occurrence of an error in the first L2P entry. In some implementations, to detect the first L2P CRC failure of the first L2P entry, the processing device may retrieve the CRC encoding value of the first L2P entry, decode the first L2P entry using the CRC encoding value to generate a CRC decoding value, and compare the CRC decoding value with a preset value to determine whether the first L2P CRC failure occurs.

At operation 630, the processing device may identify a second physical address according to a match of the first logical address with metadata of the second physical address. In some implementations, to identify the second physical address, the processing device may compare the first logical address with a plurality of metadata stored in the non-volatile memory device and find the match of the first logical address with the metadata, of the plurality of metadata, of the second physical address. In some implementations, the metadata of the second physical address comprises a logical block address.

At operation 640, the processing device may write a second L2P entry (e.g., entry 415) in the L2P mapping data structure using a post package repair (PPR) spare row of the volatile memory device, wherein the second L2P entry maps the second physical address (e.g., PBA mmmA) to the first logical address (e. g., LBA xxx1).

At operation 650, the processing device may point the first L2P entry to the second L2P entry. In some implementations, pointing the first L2P entry to the second L2P entry is performed via a pointer (e.g., pointer A in entry 410) associated with the first L2P entry. In some implementations, the processing device may send the data retrieved from the second physical address in response to the read request.

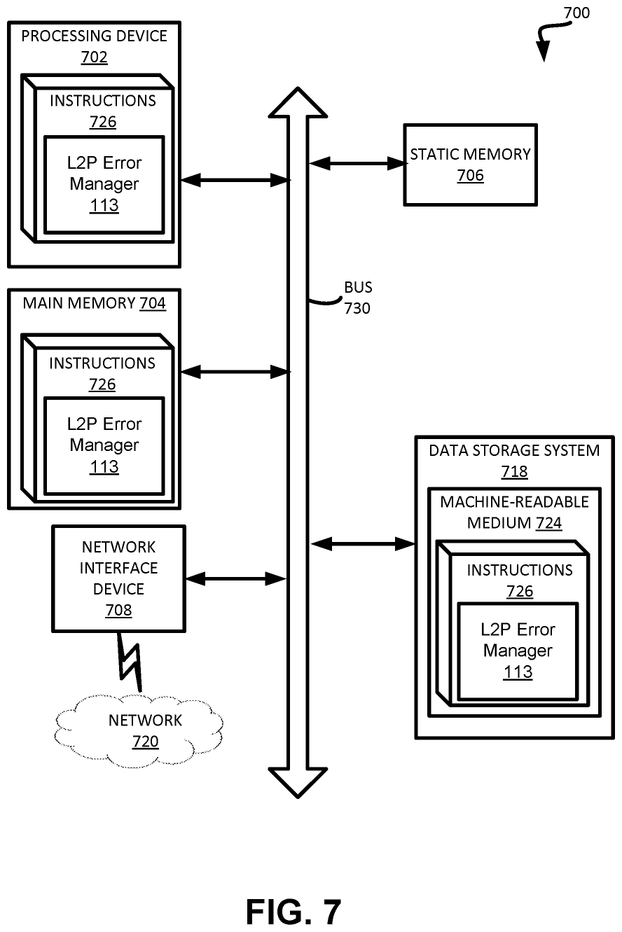

FIG. 7 illustrates an example machine of a computer system 700 within which a set of instructions, for causing the machine to perform any one or more of the methodologies discussed herein, can be executed. In some embodiments, the computer system 700 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the L2P error manager 113 of FIGS. 1-3). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM) or RDRAM, etc.), a static memory 706 (e.g., flash memory, static random access memory (SRAM), etc.), and a data storage system 718, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 726 for performing the operations and steps discussed herein. The computer system 700 can further include a network interface device 708 to communicate over the network 720.

The data storage system 718 can include a machine-readable storage medium 724 (also known as a computer-readable medium) on which is stored one or more sets of instructions 726 or software embodying any one or more of the methodologies or functions described herein. The instructions 726 can also reside, completely or at least partially, within the main memory 704 and/or within the processing device 702 during execution thereof by the computer system 700, the main memory 704 and the processing device 702 also constituting machine-readable storage media. The machine-readable storage medium 724, data storage system 718, and/or main memory 704 can correspond to the memory sub-system 110 of FIG. 1.

In one embodiment, the instructions 726 include instructions to implement functionality corresponding to a component (e.g., the L2P error manager 113 of FIGS. 1-3). While the machine-readable storage medium 724 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a non-volatile memory device;
a volatile memory device, wherein the volatile memory device stores a logical to physical (L2P) mapping data structure, wherein the L2P mapping data structure includes a plurality of L2P entries, and wherein each L2P entry of the plurality of L2P entries maps a logical address to a corresponding physical address; and
a processing device, operatively coupled with the volatile memory device and the non-volatile memory device, to perform operations comprising:
writing, in a first L2P entry of the plurality of L2P entries, a first logical address
specified in a write request and a first physical address;
encoding the first L2P entry by applying a cyclic redundancy check (CRC) code
to the first L2P entry to generate a CRC encoding value of the first L2P entry;
storing the CRC encoding value of the first L2P entry in the non-volatile memory
device;
receiving a read request to read data stored in the non-volatile memory device,
wherein the read request includes the first logical address; and
detecting, using the CRC encoding value of the first L2P entry, a first L2P CRC
failure of the first L2P entry, wherein the first L2P CRC failure of the first L2P entry
indicates an occurrence of an error in the first L2P entry.

2. The system of claim 1, wherein the processing device is to perform operations further comprising:
identifying a second physical address according to a match of the first logical address with metadata of the second physical address;
writing a second L2P entry in the L2P mapping data structure using a post package repair (PPR) spare row of the volatile memory device, wherein the second L2P entry maps the second physical address to the first logical address; and
pointing the first L2P entry to the second L2P entry.

3. The system of claim 2, wherein identifying the second physical address further comprises:
comparing the first logical address with a plurality of metadata stored in the non-volatile memory device; and
finding the match of the first logical address with the metadata, of the plurality of metadata, of the second physical address.

4. The system of claim 2, wherein pointing the first L2P entry to the second L2P entry is performed via a pointer associated with the first L2P entry.

5. The system of claim 2, wherein the processing device is to perform operations further comprising:
sending the data retrieved from the second physical address in response to the read request.

6. The system of claim 1, wherein detecting the first L2P CRC failure of the first L2P entry comprises:
retrieving the CRC encoding value of the first L2P entry;
decoding the first L2P entry using the CRC encoding value to generate a CRC decoding value; and
comparing the CRC decoding value with a preset value to determine whether the first L2P CRC failure occurs.

7. The system of claim 1, wherein the non-volatile memory device comprises a dynamic random access memory (DRAM) device.

8. A method, comprising:
writing, by a processing device operatively coupled with a volatile memory device and a non-volatile memory device, in a first L2P entry of a plurality of L2P entries, a first logical address specified in a write request and a first physical address, wherein the volatile memory device stores a logical to physical (L2P) mapping data structure, wherein the L2P mapping data structure includes the plurality of L2P entries, and wherein each L2P entry of the plurality of L2P entries maps a logical address to a corresponding physical address;
encoding the first L2P entry by applying a cyclic redundancy check (CRC) code to the first L2P entry to generate a CRC encoding value of the first L2P entry;
storing the CRC encoding value of the first L2P entry in the non-volatile memory device;
receiving a read request to read data stored in the non-volatile memory device, wherein the read request includes the first logical address; and
detecting, using the CRC encoding value of the first L2P entry, a first L2P CRC failure of the first L2P entry, wherein the first L2P CRC failure of the first L2P entry indicates an occurrence of an error in the first L2P entry.

9. The method of claim 8, further comprising:
identifying a second physical address according to a match of the first logical address with metadata of the second physical address;
writing a second L2P entry in the L2P mapping data structure using a post package repair (PPR) spare row of the volatile memory device, wherein the second L2P entry maps the second physical address to the first logical address; and
pointing the first L2P entry to the second L2P entry.

10. The method of claim 9, wherein identifying the second physical address further comprises:
comparing the first logical address with a plurality of metadata stored in the non-volatile memory device; and
finding the match of the first logical address with the metadata, of the plurality of metadata, of the second physical address.

11. The method of claim 9, wherein pointing the first L2P entry to the second L2P entry is performed via a pointer associated with the first L2P entry.

12. The method of claim 9, further comprising:
sending the data retrieved from the second physical address in response to the read request.

13. The method of claim 8, wherein detecting the first L2P CRC failure of the first L2P entry comprises:
retrieving the CRC encoding value of the first L2P entry; and
decoding the first L2P entry using the CRC encoding value to generate a CRC decoding value; and
comparing the CRC decoding value with a preset value to determine whether the first L2P CRC failure occurs.

14. The method of claim 11, wherein the non-volatile memory device comprises a dynamic random access memory (DRAM) device.

15. A non-transitory computer-readable storage medium comprising instructions that, when executed by a processing device, operatively coupled with a volatile memory device and a non-volatile memory device, cause the processing device to perform operations comprising:
writing, in a first L2P entry of a plurality of L2P entries, a first logical address specified in a write request and a first physical address, wherein the volatile memory device stores a logical to physical (L2P) mapping data structure, wherein the L2P mapping data structure includes the plurality of L2P entries, and wherein each L2P entry of the plurality of L2P entries maps a logical address to a corresponding physical address;
encoding the first L2P entry by applying a cyclic redundancy check (CRC) code to the first L2P entry to generate a CRC encoding value of the first L2P entry;
storing the CRC encoding value of the first L2P entry in the non-volatile memory device;
receiving a read request to read data stored in the non-volatile memory device, wherein the read request includes the first logical address; and
detecting, using the CRC encoding value of the first L2P entry, a first L2P CRC failure of the first L2P entry, wherein the first L2P CRC failure of the first L2P entry indicates an occurrence of an error in the first L2P entry.

16. The non-transitory computer-readable storage medium of claim 15, wherein the processing device is to perform operations further comprising:
identifying a second physical address according to a match of the first logical address with metadata of the second physical address;
writing a second L2P entry in the L2P mapping data structure using a post package repair (PPR) spare row of the volatile memory device, wherein the second L2P entry maps the second physical address to the first logical address; and
pointing the first L2P entry to the second L2P entry.

17. The non-transitory computer-readable storage medium of claim 16, wherein identifying the second physical address further comprises:
comparing the first logical address with a plurality of metadata stored in the non-volatile memory device; and
finding the match of the first logical address with the metadata, of the plurality of metadata, of the second physical address.

18. The non-transitory computer-readable storage medium of claim 16, wherein the processing device is to perform operations further comprising:
sending the data retrieved from the second physical address in response to the read request.

19. The non-transitory computer-readable storage medium of claim 15, wherein detecting the first L2P CRC failure of the first L2P entry comprises:
retrieving the CRC encoding value of the first L2P entry; and
decoding the first L2P entry using the CRC encoding value to generate a CRC decoding value; and
comparing the CRC decoding value with a preset value to determine whether the first L2P CRC failure occurs.

20. The non-transitory computer-readable storage medium of claim 15, wherein the non-volatile memory device comprises a dynamic random access memory (DRAM) device.
